(19) United States
(12) Patent Application Publication
(10) Pub. No.: US 2026/0185692 A1
(43) Pub. Date: Jul. 2, 2026

(54) WATERPROOF MINI LED MODULE

(71) Applicant: Rishang Optoelectronics Co., Ltd., Shenzhen (CN)

(72) Inventors: Gang Huang, Shenzhen (CN); Jun Liang, Shenzhen (CN); Dulin Tao, Shenzhen (CN); Feng Luo, Shenzhen (CN); Xiaomin Yan, Shenzhen (CN)

(21) Appl. No.: 19/001,825

(22) Filed: Dec. 26, 2024

(51) Int. Cl. F21V 31/00; F21S 2/00; F21Y 115/10

(52) U.S. Cl. CPC F21V 31/005; F21S 2/005; F21S 4/20; F21V 15/01; F21Y 2115/10

(57) ABSTRACT

A Mini LED module with good waterproof performance, includes a housing, and a bottom case provided at bottom side of the housing, the housing and the bottom case are both integrally formed. A PCBA is provided inside the housing, a mounting post is provided at both ends of the inner side of the housing, and a mounting hole are provided in the PCBA, the mounting post is fitted and joints with the mounting holes. The housing is made of transparent silicone, the PCBA is sprayed with a layer of silica gel by dispensing equipment, and a sealing ring is provided between the housing and the bottom case. With the layer of silica gel sprayed on the PCBA, and a sealingly installation of the PCBA through the housing and the bottom, PCBA can have a double-layer protection. The integrally formed housing and bottom case contribute to a sealing waterproof function.

### FIELD

The present disclosure relates to a field of Mini LEDs, specifically to a Mini LED module having a good water-proof performance.

### BACKGROUND

With the development of technology, Mini LED module display technology has appeared. Compared with traditional LEDs, the Mini LED module has characteristics of high brightness, better luminous efficiency, lower power consumption, and a very wide application prospect. The Mini LED module is often installed in lighting fixtures, and the lighting fixtures usually improve lighting intensity through a simultaneous operation of a number of lamp beads on the Mini LED module. However, waterproof performances of a traditional LED lighting fixtures mainly depend on sealing of a housing thereof, and the lamp beads and circuit boards may get damaged in short-circuit, when external moister enters into the interior of the housing and easily intrude into the inside of Mini LED module.

During researching the technical solution of the Mini LED module of the present disclosure, inventors have found that the above technology at least has technical problems as follows.

One of the technical problems is that current modules mostly involve an assembly-type installation, which may cause multiple connection gaps between various components. Meanwhile, there is only the housing provide one single layer of protection for most of the components of the PCBA (Printed Circuit Board Assembly), and the protection level is relatively low, which makes it difficult to operate in a long-term water flow environment during outdoor use.

Another technical problem is that current optical products are relatively large in size, with a width mostly of 17 mm, making it difficult to applied in an application environment relatively narrow or having a width ≤17 mm.

To solve the above problems, a Mini LED module with good waterproof performance is proposed to solve the above problems.

### SUMMARY

One of the objectives of the present disclosure is to provide a Mini LED module with good waterproof performances, which can effectively solve the problems in the background.

In order to realize the above objective, the present disclosure adopts technical solutions as follows.

A Mini LED module with good waterproof performance is provided, including a housing, a bottom case located in a middle of a bottom side of the housing, with both the housing and bottom case integrally molded, and a PCBA Printed Circuit Board Assembly) positioned at a middle of an inner side of the housing, with a mounting post formed at both ends of the inner side of the housing and a mounting hole provided at both ends of a middle of the PCBA, and the mounting post is fitted and joints with the mounting hole; wherein, the housing is made of transparent silicone, a surface of the PCBA is sprayed with a layer of silica gel by a dispensing equipment, and a sealing ring is provided at a connection between the housing and the bottom case.

By spraying a layer of silica gel on an upper surface of the PCBA, and then forming a sealingly installation of the PCBA by the housing and the bottom case, a double layer of protection of the PCBA can be achieved, thus improving the protection level of the PCBA, further to protect the PCBA from external collisions or water damages.

Herein, the dispensing equipment includes a positioning structure, the positioning structure including a base, and a holding plate positioned at a middle of an upper side of the base, with a positioning post formed on both ends of the upper side of the base, and the positioning post is slidably connected with two ends of the placing plate. A telescopic rod is provided in the middle of the bottom side of the holding plate, and a base part of the telescopic rod is fixedly mounted in the middle of the upper side of the base.

The positioning structure can function to position and fix the PCBA, thus facilitating the dispensing equipment to dispense gel on the upper surface of the PCBA, thus improving the dispensing accuracy of the PCBA.

The PCBA can be pushed out from two positioning posts by pushing the holding plate upward through the telescopic rod, thus realizing quick disassembly and removal of the PCBA.

In one embodiment, a sliding slot is provided at the middle of the bottom side of the base, and a mounting plate is slidably mounted in the middle of the inner side of the sliding slot.

With the sliding slot sliding horizontally on the middle of the upper side of the mounting plate, a quick mounting of the base can be achieved.

In one embodiment, the base and mounting plate are fixedly connected by a limitation structure, the limitation structure includes an insertion rod, the insertion rod is slidably mounted in the middle of both ends of the base, and the mounting plate is provided with an insertion hole at both ends of the upper side, and a bottom of the insertion rod is slidably mounted in a middle of an inner side of the insertion hole.

The position of the base can be limited and fixed by the limitation structure, to avoid a sliding situation during use of the base.

In one embodiment, the middle of both ends of the base are provided with a mounting cavity, the insertion rod slides vertically in a middle of an inner side of the mounting cavity, a spring is provided in the middle of the inner side of the mounting cavity, and the insertion rod passes through and extends out of an inner cavity of the spring.

The elastic force generated by the spring facilitates the elastic reset of the insertion rod after the insertion is lifted, thus allowing the bottom of the insertion rod to be re-inserted into the insertion hole.

In one embodiment, a limitation block is provided at the middle of the bottom of the insertion rod, wherein the limitation block is located in the inner bottom of the mounting cavity, and the limitation block is in contact with a bottom end of the spring.

With the resistance of the limitation block, the insertion rod can be prevented from slipping out of the mounting cavity to further cause a situation of detachment.

In a further embodiment, the insertion rod is provided with a circular limitation head at a top of the insertion rod, the limitation head being located at the middle of both ends of the base.

The limitation head can be pulled, to facilitate lifting and pulling up of the insertion rod, and the connection between the insertion rod and the insertion hole can be disconnected and separated, so that the base can be quickly disassembled.

Compared with related arts, the present disclosure at least has following beneficial effects.

Dispensing accuracy of the dispensing equipment can be improved, by fixing the PCBA through the positioning structure. A double-layer protection of the PCBA can be realized by spraying a layer of silica gel on the surface of the PCBA, and forming a sealing installation of the PCBA by the housing and the bottom case. Meanwhile, compared with the traditional product having multiple connection gaps, the present disclosure may achieve an improved protection level, and has a better sealing and waterproof performance, by producing the housing and the bottom case via integrally back injection molding, with only one connection part formed between the housing and the bottom case.

Besides, by integrally injection molding the housing and the bottom case, the width of the product can be reduced to 13 mm, thus increasing the application environment of the product, making it possible to use the product in environments where the width is ≤17 mm and ≥13 mm.

### BRIEF DESCRIPTION OF THE DRAWINGS

FIG. 1 is a diagram showing an overall structure of a Mini LED module with good waterproof performance according to an embodiment of the present disclosure.

FIG. 2 is a diagram showing a disassembled plan view of a Mini LED module with good waterproof performance according to an embodiment of the present disclosure.

FIG. 3 is a diagram showing a structure of a positioning structure in a Mini LED module with good waterproof performance according to an embodiment of the present disclosure.

FIG. 4 is a diagram showing an exploded view of a positioning structure in a Mini LED module with good waterproof performance according to an embodiment of the present disclosure.

FIG. 5 is a diagram showing a side sectional structure of a positioning structure in a Mini LED module with good waterproof performance according to an embodiment of the present disclosure.

FIG. 6 is a diagram showing a side sectional structure of a restriction structure in a Mini LED module with good waterproof performance according to an embodiment of the present disclosure.

In the figures, the representation of each reference sign is as follows.
1, housing; 2, mounting post; 3, PCBA; 30, mounting hole; 4, bottom case; 5, base; 6, holding plate; 7, positioning post; 8, telescopic rod; 80, base part; 9, limitation head; 10, mounting cavity; 11, insertion rod; 12, spring; 13, limitation block; 14, sliding slot; 15, mounting plate; 16, insertion hole.

### DETAILED DESCRIPTION

Implementations of the present disclosure will now be described, by way of embodiments only, with reference to the drawings. It should be understood that the specific embodiments described here are only used to explain but not to limit the present application. Based on the embodiments in the present application, all other embodiments obtained by one ordinary skill in the art without creative labor is within the scope of the present application.

In the description of the present application, it should be understood that the terms “center”, “longitudinal”, “lateral”, “length”, “width”, “thickness”, “top”, “bottom”, “front”, “back”, “left”, “right”, “vertical”, “horizontal”, “top”, “bottom”, “inside”, “outside”, “clockwise”, and “counterclockwise” are used to indicate orientation or positional relationship based on the orientation or positional relationship shown in the attached drawings, and are only for the convenience of describing and simplifying the present application, rather than indicating or implying that the device or component referred to must have a specific orientation or be constructed and operated in a specific orientation. Therefore, the above terms cannot be understood as a limitation of the present application. In addition, the terms “first” and “second” are only used for describing and cannot be understood as indicating or implying relative importance or implying the quantity of features referred to. Therefore, the feature described by the term “first” or “second” may explicitly or implicitly include one or more features. In the description of the present application, “a plurality of” means two or more, unless otherwise specified.

In the description of the present application, it should be noted that unless otherwise specified and limited, the terms “install”, “couple”, and “connect” should be broadly understood, for example, they can be fixed connections, detachable connections, or integrated connections, and can also be mechanical connection, electrical connection, or communication with each other, and can also be directly connection, indirectly connection through an intermediate medium, or the internal communication or interaction between two components. For one ordinary skill in the art, the specific meanings of the above terms in the present application can be understood based on specific circumstances.

In the present application, unless otherwise explicitly specified and limited, when describing a first feature is located “above” or “below” a second feature, the first feature may be in a direct contact with the second feature or not in a direct contact with the second feature through an additional feature between them. Moreover, when describing the first feature is located “above”, “over” or “on” the second feature, the first feature may be right above or diagonally above the second feature, indicating that the first feature is horizontally higher than the second feature. When describing the first feature is located “below”, “under”, or “down” the second feature, the first feature may be right below and diagonally below the second feature, indicating that the first feature is horizontally lower than the second feature.

The following disclosure provides multiple embodiments or examples to implement different structures of the present application. In order to simplify the disclosure of the present application, specific examples of components and configurations will be described below. Of course, they are only examples and are not intended to limit the present application. In addition, the present application may use same reference numeric or letter in different examples for simplification and clarity, which does not used to indicate the relationship between the various embodiments and/or configurations. In addition, the present application provides examples of various specific processes and materials, but one ordinary skill in the art may realize that other processes and/or materials can also be used.

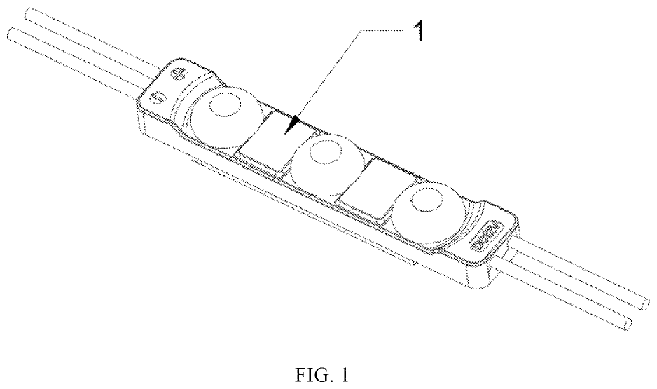

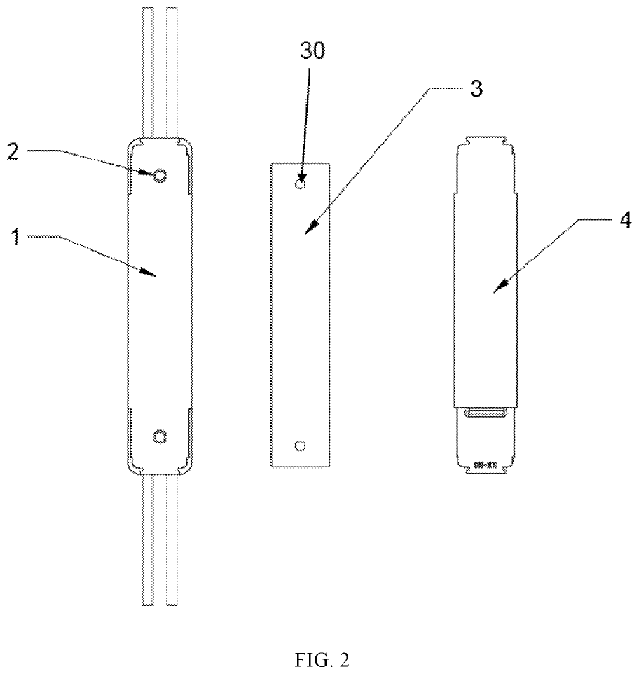

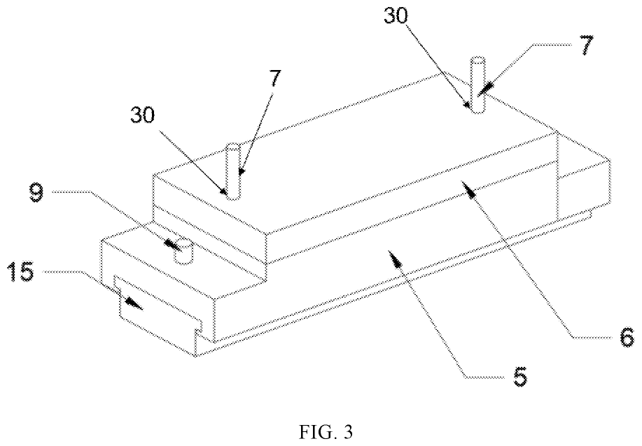

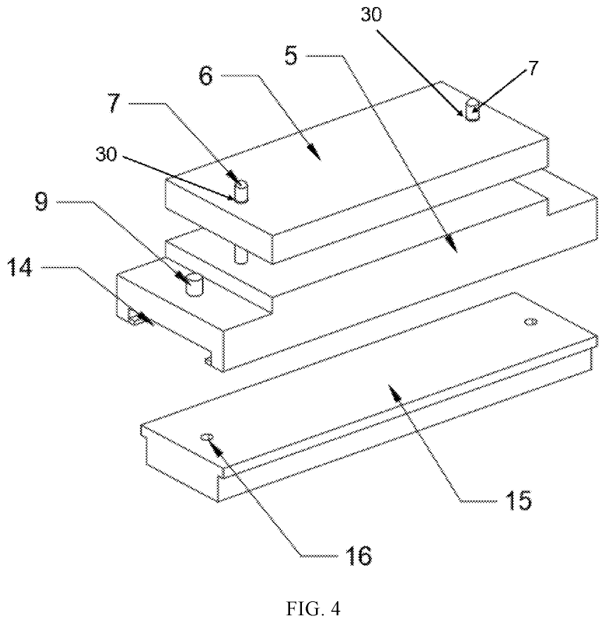

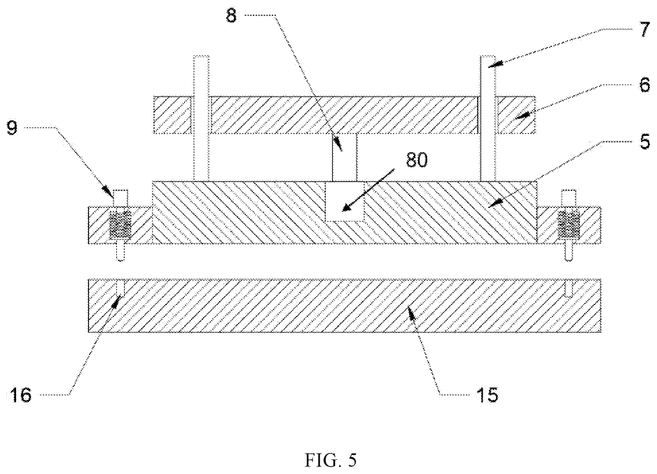

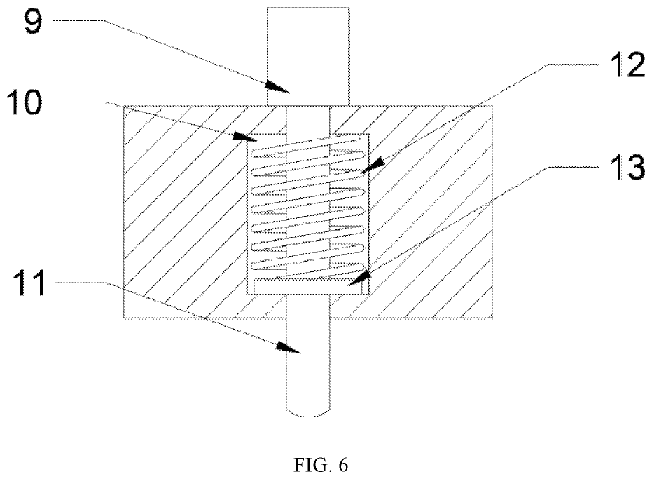

Referring to FIGS. 1-6, in a waterproof Mini LED module of the disclosure, a double layer protection of a PCBA 3 can be realized, by firstly fixing and limiting the PCBA 3 via a positioning structure to improve dispensing accuracy of the dispensing equipment to the PCBA 3 when it is needed to spay silicone to a surface of the PCBA 3, and by spraying a layer of silica gel on the surface of the PCBA 3 and then sealing and installing the PCBA 3 by the housing 1 and the bottom case 4. Meanwhile, compared with the traditional product having multiple connection gaps, the present disclosure may achieve an improved protection level, and has a better sealing and waterproof performance, by producing the housing 1 and the bottom case 4 via integrally back injection molding, with only one connection part formed between the housing 1 and the bottom case 4.

Besides, by producing the housing 1 and the bottom case 4 through integrally injection molding, it is also possible to reduce the width of the product to 13 mm, thereby increasing the application environment of the product, so that the product can be used in an environment where the width is ≤17 mm and ≥13 mm.

### Embodiment 1

Referring to FIGS. 1-6, a Mini LED module with good waterproof performance includes a housing 1. A bottom case 4 is provided at the middle of the bottom side of the housing 1, and the housing 1 and the bottom case 4 are both integrally molded, a PCBA 3 is provided in the middle of an inner side of the housing 1, with a mounting post 2 provided in the inner side and at two ends of the housing 1, a mounting hole 30 is formed at the middle of the ends of the PCBA 3, and the mounting post 2 is adapted to and jointed with the mounting hole 30. The housing 1 is made of transparent silicone so as to facilitate light transmission and the diffusion of light source to the outside. A sealing ring is provided at the connection between the housing 1 and the bottom case 4. The PCBA 3 can be installed in a limited position, with fitting and joint between the mounting post 2 and the mounting hole 30, and the bottom case 4 can cover and seal the opening at the bottom of the housing 1, thus realizing the sealing protection of the PCBA 3.

A layer of silica gel is sprayed on a surface of the PCBA 3 through a dispensing equipment, which provides sealing protection to the PCBA 3 and prevent PCBA 3 from external collision or water flow damages or the like. The dispensing equipment includes a positioning structure, through which the PCBA 3 can be positioned and limited, so as to facilitate dispensing equipment to dispense gel on the upper surface of PCBA 3. The positioning structure includes a base 5, and a holding plate 6 positioned at an upper center of the base 5, with positioning post 7 formed on both sides of the upper side of the base 5. The positioning posts 7 are slidably connected with the two ends of the holding plate 6. When it is necessary to dispense gel on the PCBA 3, the PCBA 3 is firstly placed on the holding plate 6, and at the same time, two positioning posts 7 fit and joint with mounting holes 30 at two sides of the PCBA 3, so as to achieve fixing and limitation of the position of PCBA 3, and improve the dispensing accuracy to the PCBA 3.

A telescopic rod 8 is provided in the middle of the bottom of the holding plate 6, and a base part 80 of the telescopic rod 8 is fixedly mounted in the middle of the upper side of the base 5, so that when the PCBA 3 completes the dispensing processing, the telescopic rod 8 is pushed upward to the holding plate 6, so that the PCBA 3 can be took off from the two positioning posts 7, thereby realizing a rapid removal of the PCBA 3.

The present disclosure may involve a working principle in the present embodiment as follows.

When it is needed to dispense gel on the upper surface of PCBA 3, firstly the PCBA 3 is placed on the holding plate 6, and at the same time, the two positioning posts 7 fit and inserted into the mounting holes 30 on two ends of the PCBA 3, so as to realize fixing and limiting the position of the PCBA 3 to improve the dispensing accuracy to the PCBA 3, and then the PCBA 3 can be took off from the two positioning post 7 by pushing the holding plate 6 upwards via the telescopic rod 8, thus realizing a rapid removal of the PCBA 3. When finishing dispensing gel on the PCBA3, the PCBA 3 can be sealingly installed by the housing 1 and the bottom case 4, so as to enhance the protection of the PCBA3.

### Embodiment 2

Referring to FIGS. 1-6, on the basis of embodiment 1, a Mini LED module with good waterproof performance further includes following structures.

The base 5 is provided with a sliding slot 14 at the middle of the bottom side, and a mounting plate 15 is slidably mounted in the middle of an inner side of the sliding slot 14, and the mounting plate 15 can be mounted on a feeding belt of the dispensing equipment, and then the sliding slot may slide horizontally on the middle of the upper side of the mounting plate 15, so as to facilitate a rapid installation of the base 5, and when it is necessary to spray silica gel on the surface of the PCBA 3, the PCBA 3 can be transported onto the dispensing equipment through the feeding belt, so as to facilitate the accurate spraying of silica gel on the PCBA 3 by the dispensing equipment.

The base 5 and mounting plate 15 are fixedly connected by a limitation structure, the limitation structure includes an insertion rod 11, the insertion rod 11 is slidably mounted in the middle of both ends of the base 5, the mounting plate 15 is provided with an insertion hole 16 on both sides of the upper side, the bottom of the insertion rod 11 is slidably mounted in the middle of the inner side of the insertion hole 16, and the position of the base 5 is limited by inserting the ends of the insertion rod 11 into the insertion hole 16, thereby realizing a limiting position of the base 5 to avoid a sliding situation during use of the base 5.

The middle of both ends of the base 5 are provided with a mounting cavity 10, the insertion rod 11 slides vertically in the middle of the inner side of the mounting cavity 10, a spring 12 is provided in the middle of the inner side of the mounting cavity 10, the insertion rod 11 passes through and extends out of an inner cavity of the spring 12, when the insertion rod 11 is lifted upward, the insertion rod 11 will turn to the state of get disconnected and separated from the insertion hole 16, and when the insertion rod 11 loses its pulling force, position of the insertion rod 11 would reset under the elastic force generated by the spring 12, therefore realizing a insertion fitting between the end of the insertion rod 11 with the insertion hole 16 again.

A limitation block 13 is provided at the middle of the bottom of the insertion rod 11, the limitation block 13 is located in the bottom of the mounting cavity 10, the limitation block 13 is in contact with a bottom end of the spring 12, and with the resistance of the limitation block 13, the insertion rod 11 can be prevented from slipping out from the mounting cavity 10 to further cause a situation of detachment.

The insertion rod 11 is provided with a circular limitation head 9 at the top, the limitation head 9 is located at the middle of the two ends of the base 5. The limitation head 9 may be pulled up, so as to facilitate the lifting of the insertion rod 11, further to disconnect the connection between the insertion rod 11 and the insertion hole 16. Thus, the base 5 can be quickly disassembled.

The present disclosure may involve a working principle in the present embodiment as follows.

With the sliding slot 14 formed in the middle of the bottom side of the base 5, the sliding slot 14 slides horizontally on the middle of the upper side of the mounting plate 15, so as to facilitate the rapid installation of the base 5. Meanwhile, with the limitation structure located at the middle of both ends of the base 5, the limitation structure including the insertion rod 11, the end of the insertion rod 11 can be inserted into the insertion hole 16, so as to realize the limiting and fixing of the position of the base 5 to avoid a sliding situation during use of the base 5. On the contrary, when it is needed to disassemble the base 5, it is only necessary to lift up the limitation head 9 to disconnect the connection between the insertion rod 11 and the insertion hole 16, so that the base 5 can be disassembled quickly.

The above shows and describes the basic principles and main features of the utility model and the advantages of the utility model. Those skilled in the art should understand that the utility model is not limited by the above embodiments, and that the above embodiments and the description in the specification are only illustrative of the principles of the utility model, and that there will be various changes and improvements to the utility model without departing from the spirit and scope of the utility model, which fall within the scope of the utility model claimed to be protected. The scope of protection claimed for the utility model is defined by the appended claims and their equivalents.

For one ordinary skill in the art, the present application is not limited to the details of the exemplary embodiments mentioned above, and can be implemented in other specific embodiments without departing from the spirit or basic features of the present application. Therefore, from any perspective, the above embodiments should be regarded as exemplary but not restrictive. The scope of the present application is limited by the accompanying claims rather than the above description, and therefore all variations within the principles and scope of the equivalent elements of the claims is still included in the present application.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

1. A waterproof Mini LED module, comprising: a housing, a bottom case located in a middle of a bottom side of the housing, with both the housing and bottom case formed as separate integrally molded structures, and a PCBA (Printed Circuit Board Assembly) positioned at a middle of an inner side of the housing, with a mounting post formed at both ends of the inner side of the housing and a mounting hole provided at both ends of a middle of the PCBA, and the mounting post is fitted and joints with the mounting hole; wherein,
the housing is made of transparent silicone, a surface of the PCBA is sprayed with a silica gel by a dispensing equipment;
the dispensing equipment comprises a positioning structure, the positioning structure comprises a base, and a holding plate positioned at a middle of an upper side of the base, with a positioning post formed on both ends of the upper side of the base, and the positioning post is slidably connected with two ends of the placing plate;
the holding plate is provided with a telescopic pole in a middle of a bottom side, and the telescopic pole has a base part fixedly mounted in a middle of the upper side of the base;
wherein the waterproof Mini LED module further comprises a sliding slot provided at a middle of a bottom side of the base, and a mounting plate slidably provided in a middle of an inner side of the sliding slot,
the base and the mounting plate are fixedly connected by a limitation structure, the limitation structure includes an insertion rod;
a middle of two ends of the base is provided with a mounting cavity, a spring is provided in a middle of an inner side of the mounting cavity, a limitation block is provided at a middle of a bottom of the insertion rod,
a top of the insertion rod is provided with a circular limitation head.

2. (canceled)

3. The waterproof Mini LED module according to claim 1, wherein the insertion rod is slidably mounted in the middle of both ends of the base, and the mounting plate is provided with an insertion hole at both ends of an upper side of the mounting plate, and a bottom of the insertion rod is slidably mounted in a middle of an inner side of the insertion hole.

4. The waterproof Mini LED module according to claim 3, wherein the insertion rod slides vertically in a middle of an inner side of the mounting cavity, and the insertion rod passes through and extends out of an inner cavity of the spring.

5. The waterproof Mini LED module according to claim 4, wherein the limitation block is located in an inner bottom of the mounting cavity, and the limitation block is in contact with a bottom end of the spring.

6. (canceled)
